(19) United States
(12) Patent Application Publication
(10) Pub. No.: US 2025/0392123 A1
(43) Pub. Date: Dec. 25, 2025

(54) SYSTEM AND METHOD FOR INVERTER CONTROL

(71) Applicant: RES Digital Solutions Limited, Hertfordshire (GB)

(72) Inventors: Alex CLERC, Denver, CO (US); Brendan TAYLOR, Denver, CO (US); Alexander BAMBERGER, Denver, CO (US)

(21) Appl. No.: 19/244,984

(22) Filed: Jun. 20, 2025

Related U.S. Application Data
(60) Provisional application No. 63/662,320, filed on Jun. 20, 2024.

(51) Int. Cl. H02J 3/00

(52) U.S. Cl. CPC H02J 3/001

(57) ABSTRACT

Solar inverters and systems, controllers, and methods of control for solar inverters are disclosed. A method for optimizing a solar inverter can include determining a maximum temperature setpoint, modifying a temperature start point below the maximum temperature setpoint, adjusting a current temperature of a solar inverter from the temperature start point towards the maximum temperature setpoint by regulating a component temperature of a component of the solar inverter, and optimizing the current temperature of the solar inverter via making a best choice between power limiting and selective disabling of components within the solar inverter. The method can be embodied on a non-transitory computer-readable medium storing instructions that, when executed by a processor of a computing system, causes the computing system to perform the method.

### CROSS-REFERENCE TO RELATED APPLICATION

This application claims priority to U.S. Provisional Patent Application No. 63/662,320, filed 20 Jun. 2024, and entitled “System and Methods for Inverter Optimization,” which is hereby incorporated by reference in its entirety.

### FIELD

The described embodiments relate generally to inverter control and more particularly to systems and methods for optimizing power production by inverters, while minimizing inverter downtime.

### BACKGROUND

Recent advances in solar power inverters have enabled wide-scale use of solar power generation. Solar inverters can be used in a variety of different locations with different environmental and efficiency variables. Heat, exposure to various environments, and extended use can put a strain on conventional solar inverters, causing issues requiring regular maintenance. In many situations, solar inverters or components thereof can overheat. Conventional solar inverters can be modular, where a solar inverter is composed of multiple modules. Each of the modules of a solar inverter can have an individual temperature measurement and operational status. Solar inverters can trip, fault, or otherwise be rendered inoperable if the individual modules of the solar inverter overheat (such as on a hot day), causing lost production. To improve the performance of solar inverters, maintenance is regularly requested to manually reduce solar inverter power, such as for days with high forecasted temperatures. This process is manual, inefficient, and inaccurate.

Thus, it can be desirable to provide solar inverters that can dynamically read the temperatures of different modules of the solar inverters and reduce power conversion by the modules before they reach their maximum temperature using a control system. This can enable the solar inverter to actively adapt to different temperatures, maximizing power output and efficiency, while preventing overheating.

### SUMMARY

According to an embodiment, a solar inverter controller can include a non-transitory computer-readable medium storing instructions that, when executed by a processor of a computing system, cause the computing system to perform a method for optimizing a solar inverter. In some examples, the method includes determining a max temperature setpoint, modifying a temperature start point below the max temperature setpoint, adjusting a current temperature of the solar inverter from the temperature start point to the max temperature setpoint via regulating the temperature of a module disposed within the solar inverter, and optimizing temperature changes via power limiting.

An aspect of the present disclosure relates to a non-transitory computer-readable medium storing instructions that, when executed by a processor of a computing system, cause the computing system to perform a method for optimizing a solar inverter. The method can include determining a maximum temperature setpoint, modifying a temperature start point below the maximum temperature setpoint, adjusting a current temperature of a solar inverter from the temperature start point towards the maximum temperature setpoint by regulating a component temperature of a component of the solar inverter, and optimizing the current temperature of the solar inverter via making a best choice between power limiting and selective disabling of components within the solar inverter.

In some examples, the current temperature of the solar inverter can be optimized by selectively providing the power limiting by providing a power limit to the solar inverter to maintain the current temperature below the temperature start point or providing the selective disabling of the components within the solar inverter by selectively disabling one or more of the components to maintain the current temperature below the temperature start point. In some examples, the code can be further executable by the processor of the computing system to calculate a power curtailment for the solar inverter based on the current temperature. The power limit can be provided based on the power curtailment. The temperature start point can be adjusted to the current temperature of the solar inverter based further on the power curtailment.

In some examples, the maximum temperature setpoint can be based on the component of the solar inverter. The temperature start point can be lower than the maximum temperature setpoint by a threshold value. In some examples, the current temperature of the solar inverter can be adjustable in a range bounded by the temperature start point and the maximum temperature setpoint.

Another aspect of the present disclosure relates to a method for controlling a power inverter. The method can include receiving temperature data from a power inverter module of a power inverter, determining a power curtailment for the power inverter, and maintaining the temperature data below a temperature setpoint. The temperature data can be maintained below the temperature setpoint by selectively adjusting a power limit of the power inverter by the power curtailment or selectively disabling one or more components of the power inverter.

In some examples, the method can further include adjusting the temperature setpoint to an adjusted temperature setpoint based on the power curtailment. The method can further include increasing the temperature setpoint to the adjusted temperature setpoint when the temperature data is greater than the temperature setpoint. In some examples, the temperature setpoint can be increased to the adjusted temperature by an amount proportional to the power curtailment. The method can further include decreasing the temperature setpoint to the adjusted temperature setpoint when the power curtailment is zero.

In some examples, the power curtailment can be determined based on the temperature data and a maximum allowed temperature of the power inverter module. In some examples, an initial value of the temperature setpoint can be set equal to a difference between a maximum allowed temperature of the power inverter module and a threshold value. A minimum value of the temperature setpoint can be equal to the initial value of the temperature setpoint.

In some examples, the method can further include applying a low pass filter to the temperature data to produce filtered temperature data. The power curtailment can be determined based on the filtered temperature data.

Yet another aspect of the present disclosure relates to a system including an inverter including a plurality of power inverter components and a controller coupled to the inverter. The inverter can be configured to receive temperature data from the power inverter components, calculate a calculated power limit for the inverter based on the temperature data, calculate a power limit lower limit for the inverter based on potential power loss from risk of the power inverter components becoming inoperative, and adjust a power limit of the inverter to the greater of the calculated power limit or the power limit lower limit.

In some examples, the calculated power limit can be calculated in a range bounded by a lower limit greater than zero and an upper limit of 100%. The calculated power limit can be calculated based on determining a power curtailment for the inverter and calculating the calculated power limit based on a difference between a maximum power limit and the power curtailment. The power curtailment can be based on a difference between a temperature setpoint and the temperature data.

In some examples, the calculated power limit is calculated based on determining a power curtailment for the inverter, the power curtailment being calculated according to the equation:

$$Power curtailment = \frac{\sum Error loss prediction}{\sum Rated power} .$$

The calculated power limit can be calculated according to the equation:

$$Power limit = Max ( 0 \% , Min ( 100 \% , 100 \% ⋆ ( max power limit - Power curtailment ) .$$

In some examples, the system can further include calculating a temperature setpoint for the inverter according to the equation:

$$Current temperature setpoint = Previous temperature setpoint + ( \frac{Power Curtailment}{5} ) * Loop Time .$$

In some examples, the previous temperature setpoint can be increased to the current temperature setpoint when the temperature data is greater than the previous temperature setpoint. The previous temperature setpoint can be decreased to the current temperature setpoint when the power curtailment has a value of zero.

In some examples, the temperature setpoint can be adjusted over time based on the temperature data and the power curtailment. The temperature setpoint can be increased to an updated temperature setpoint when the temperature data is greater than the temperature setpoint. The temperature setpoint can be decreased to the updated temperature setpoint when the power curtailment has a value of zero.

In some examples, the power limit lower limit can be calculated based on the temperature data, power data received from the power inverter components, and a downtime factor. In some examples, the controller can include a proportional (P), an integral (I), a derivative (D), a proportional-integral (PI), a proportional derivative (PD), or a proportional-integral-derivative (PID) controller.

Note that various examples and embodiments described above can be combined with any other examples and embodiments described. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a schematic view of an inverter system.

FIG. 2 illustrates a block diagram of control logic for an inverter.

FIG. 3 illustrates a block diagram of a power limit calculation.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The present disclosure relates generally to the control of inverters (e.g., solar inverters). Improvements of the present disclosure can be used to optimize the inverters, to facilitate increased efficiency and power output by the inverters, and to reduce down-time and maintenance of the inverters. Inverters can be used in a variety of different locations with different environmental and efficiency variables. Heat, exposure to various environments, and extended use can put a strain on inverters, causing issues that require regular maintenance. In many situations, inverters or components thereof can overheat. Conventionally, inverters can be modular and can be composed of multiple modules. Each of the modules of an inverter can have individual temperature measurements and operational statuses. Inverters can trip, fault, or otherwise be rendered inoperable if the individual modules of the inverters overheat (such as on a hot day), causing lost production. To improve the performance of inverters, maintenance is regularly requested to manually reduce inverter power, such as for days with high forecasted temperatures.

The present disclosure describes systems, procedures, methods, and/or components that can be used for temperature control in inverters to avoid overheating the inverters or components or modules thereof. These systems, procedures, methods, and/or components can use power limiting (e.g., by limiting power conversion from an inverter or from individual components or modules thereof), disabling problematic modules (e.g., by disabling specific components or modules of an inverter), and modifying a control setpoint (e.g., by controlling temperature setpoints for an inverter or components or modules thereof) to maximize overall power conversion by an inverter, while preventing overheating and down-time in the inverter and the modules thereof. In some examples, this can include initially setting a control setpoint temperature for a module relatively far from a maximum temperature of the module and adjusting the control setpoint temperature towards the maximum temperature over time. This can maximize power conversion by the module and allow the module to operate close to the maximum temperature, without overheating.

The present disclosure further describes methods of obtaining a maximum operating temperature for an inverter and maintaining the maximum operating temperature. In some examples, solar inverters can be initiated below a configured temperature setpoint. As the solar inverter operates, the temperature of the solar inverter will start to rise. The system described herein describes a method for maintaining the temperature of solar inverters below this configured temperature setpoint to increase the power generated by the solar inverters. In some examples, this can be accomplished via intelligently turning off portions of the inverter to regulate inverter temperature. In some examples, the system can use a network of controllers coupled to the inverters to dynamically read the temperatures of different inverter modules and derate modules within the solar inverters before the solar inverters reach their maximum temperature.

In some examples, the system can adjust the temperature of the solar inverters back and forth as they increase in temperature. Furthermore, the configured temperature setpoint of the solar inverters can continue to increase in proportion to the current temperature of the generating solar inverters. For example, each time the solar inverter temperature approaches the configured temperature setpoint, the system can limit the power of the solar inverter to decrease the temperature. Furthermore, after derating the solar inverter, the configured temperature setpoint is increased to enable the solar inverter to continue operating, this iteration to a slightly higher temperature. This process can continue until the configured temperature setpoint reaches the maximum operating temperature of the solar inverter. Using this see-saw-like process, the control system can slowly increase the temperature of one or more solar inverters to maximize the power generation of the solar inverters without the solar inverters overheating. In this manner, the system can thus enable the solar inverter to actively adapt to different temperatures, further maximizing power output and efficiency.

In some examples, multiple portions of the inverter can be in communication with a temperature-sensing system and can combine power efficiency data with external temperature data combined and internal temperature data when determining a maximum operating temperature. In further examples, the system can determine how much to curtail, or limit, the power to each solar inverter or module within a solar inverter based on temperature and power generation data. In some examples, curtailing the power of a solar inverter can help maintain temperature levels and increase the overall power efficiency of each inverter.

In some examples, the solar inverter can be configured to turn off portions of the inverter to reduce faults and/or to further regulate temperatures from exceeding temperature thresholds. In at least one example, intelligently turning off select portions of solar inverters can help avoid short circuits and other risks, therefore maximizing production. In this manner, this process can continue as a solar inverter heats up. In some examples, the temperature of a solar inverter can be regulated to slowly rise to a maximum operating temperature, thereby enhancing the efficiency of the power generation of a solar inverter.

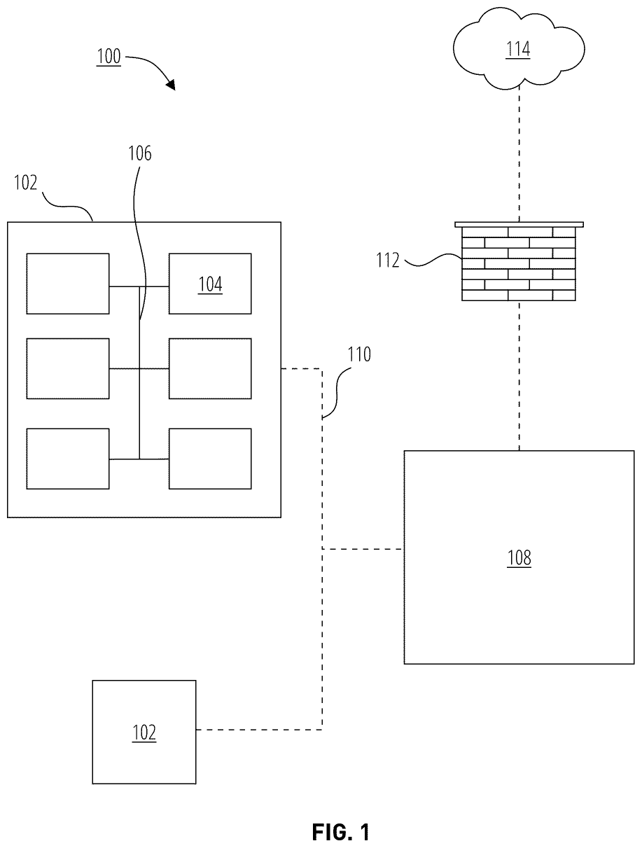

These and other embodiments are discussed below with reference to FIGS. 1 through 3. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a schematic view of a system 100. The system 100 can include one or more inverters 102, a controller 108, an external network 112, and a user interface 114. The system 100 can be a solar farm, a solar power generation facility, or a portion thereof. The system 100 (and the controller 108) can be provided for optimizing power generation from the inverters 102. The system 100 can control the inverters 102 to maximize power efficiency and/or output from the inverters 102. The system 100 can further minimize downtime and maintenance requirements for the inverters 102.

In some examples, the inverters 102 can be solar inverters that are configured to generate power from solar energy sources. More specifically, the inverters 102 can convert variable direct current (DC) outputs from photovoltaic systems, such as solar panels, into a utility frequency alternating current (AC), which can be used by an electrical network. The inverters 102 can be referred to as solar inverters, power inverters, photovoltaic (PV) inverters, converters, or the like. In other words, the inverters 102 can be components (such as converters) configured to convert solar energy (e.g., collected by photovoltaic systems) into a usable output voltage.

Each of the inverters 102 can include one or more modules 104. The modules 104 can also be referred to as components. Groups of the modules 104 can be coupled to a single bus 106 (e.g., a direct current (DC) bus) with each group of modules 104 being associated with one bus 106. Each of the inverters 102 can include one or more buses 106 and, accordingly, can include one or more groups of the modules 104. The modules 104 coupled to a single bus 106 can be disabled independently or collectively. A maximum power setpoint for each of the modules 104 coupled to a single bus 106 can be the same or can be set independently for each of the modules 104 coupled to the bus 106.

The system 100 can further include a controller 108. In some examples, the controller 108 can include a processor that can read different types of computer-readable mediums. In some examples, the controller 108 can communicate with the inverters 102 to collect data from the inverters 102 and supply control signals to the inverters 102. For example, the controller 108 can collect temperature data, error data, operational status data, energy received data, energy produced data, and the like from the modules 104 and/or the inverters 102. The controller 108 can provide control signals to the inverters 102, such as to control power setpoints, operating temperatures, operational status (e.g., enabled or disabled) and the like of the modules 104 and/or the inverters 102. The controller 108 can be a computing device, an edge box, an industrial controller, or any other suitable type of controller. The controller 108 can assist in accomplishing various control objectives pertaining to the inverters 102.

The controller 108 can include control code, which can be used to control the inverters 102. For example, the controller 108 can include control code stored in a computer-readable medium of the controller 108. In some examples, the control code can be configured to run on the controller 108. The controller 108 can include a processor configured to execute the control code stored within the computer-readable medium of the controller 108.

The controller 108 can interface with the inverters 102 through a network 110. The controller 108 can interface with the inverters 102 through any appropriate communication protocol, such as through a Modbus communication protocol. In some examples, the controller 108 can interface with the inverters 102 through the network 110. The network 110 can communicate bi-directionally, via one or more antennas, wired, or wireless links. For example, the network 110 can represent a wireless transceiver and may communicate bi-directionally with another wireless transceiver. The network 110 can also include a modem to modulate the packets and provide the modulated packets to the antennas for transmission, and to demodulate packets received from the antennas. The network 110 can connect the inverters 102 at a site together in the system 100. In some examples, the network 110 can be a server-based system that can help control the inverters 102. In some examples, the network 110 can include hardware that connects multiple inverters 102 together. In some examples, the network 110 can include various software and hardware elements sufficient to connect and monitor individual inverters 102 in the system 100. In some examples, the network 110 can enable the controller 108 to monitor multiple inverters 102 simultaneously. In some examples, the controller 108 can control systems and functionalities of the inverters 102 via the network 110.

In some examples, the system 100 can include a variety of control objectives for optimizing the inverters 102 through the controller 108. The controller 108 can assist in completing various control objectives, where different control objectives can enable the system 100 to further optimize the inverters 102. The control objectives can include, for example, maximizing production, minimizing time at high temperatures, minimizing temperature cycling, minimizing maintenance requirements, minimizing downtime, and ensuring inverter electrical protection remains enabled. In this manner, the controller 108 can increase the overall efficiency and adaptability of the inverters 102.

Overheating of the inverters 102 can cause interruptions in the power converted by the inverters 102, thus lowering the efficiency of the system 100 (e.g., a solar farm). Minimizing the time the inverters 102 spend at high temperatures, or limiting the maximum temperature of the inverters 102 can prevent the inverters 102 from overheating. In some examples, the controller 108 can receive temperature data from one or more of the modules 104 of each of the inverters 102. The controller 108 can receive this temperature data via the network 110. The controller 108 can determine a power curtailment for the inverters 102 based on the temperature data. In order to provide power curtailment for each of the inverters 102, the controller 108 can selectively curtail power generation for each of the inverters 102, curtail power generation for each of the modules 104 within the inverters 102, or enable or disable the modules 104 within the inverters 102. This can be beneficial to the system 100 in that the by controlling a power curtailment for each of the inverters 102, the controller 108 can control the temperatures of the modules 104 and the inverters 102. This can help to avoid overheating of the inverters 102. Moreover, the power curtailment for each of the inverters 102 can be set to a minimum value, therefore maximizing the power generation at each of the inverters 102.

The system 100 can maintain the temperature data supplied by the inverters 102 and/or the modules 104 below a temperature setpoint. This temperature setpoint, as described in further detail below, can be calculated by the controller 108 or input by a user of the system 100. In response to the temperature data received from the inverters 102, the controller 108 can maintain the temperatures of the inverters 102 below the temperature setpoint by selectively adjusting power limits of the inverters 102 through power curtailment. The system 100 can also limit the temperatures of the inverters 102 by selectively enabling, disabling, or regulating components of the inverters 102, such as the modules 104. For example, the controller 108 can selectively disable one or more modules 104 within an inverter 102 to maintain the temperature of the inverter 102 below the temperature setpoint.

The controller 108 can optimize the current temperature of each of the inverters 102 by making a best choice between limiting power generated by the inverter 102 and selectively disabling modules 104 within the inverter 102. In other words, the controller 108 can make the best choice in some examples by selectively limit overall power generated by the inverter 102 by curtailing how much power is generated by each module 104 of the inverter 102, or the controller 108 can disable specific modules 104 within the inverter 102. In this manner, the controller 108 can maintain a current temperature of the inverter 102 below the temperature setpoint. This can be used to maximize energy production by the inverters 102, reduce maintenance time and costs for the inverters 102, reduce replacement costs of the inverters 102, and avoid other problems caused by overheating of the inverters 102.

The controller 108 can maintain the temperatures of the inverters 102 below typical temperature thresholds. In some examples, the typical temperature thresholds can depend on the temperature ratings of each of the inverters 102 and each of the modules 104 of the inverters 102. As an example, the typical temperature threshold can be about 95° C., about 100° C., about 105° C., about 110° C., or about 115° C. The modules 104 and/or the inverters 102 can report fluctuations in temperature of the modules 104 to the controller 108 (e.g., through the network 110). The modules 104 can report a warning to the controller 108, or the controller 108 can generate a warning when the temperature of a respective module 104 rises above the typical temperature threshold.

In some examples, maintaining the reliability of the inverters 102 can be accomplished by disabling the modules 104 before warnings regarding temperature increases are reported too many times. For example, if one or more of the modules 104 are frequently reporting temperature warnings, the controller 108 can disable the modules 104. The modules 104 can be disabled for a prescribed time period, until a prescribed time of day, until a safety check has been performed on the modules 104, or the like. In some examples, this can help maintain control of the temperature of the modules 104. Electrical protection can be applied to the modules 104, even when the modules 104 are disabled. For example, the modules 104, the inverter 102, or the controller 108 can monitor leakage current from disabled modules 104 and send a signal to other modules 104, the inverter 102, or the controller 108 if a problem is detected.

The system 100 can include a user interface 114. The user interface 114 can be a web-based Human-Machine Interface (HMI). The user interface 114 can be present in or accessible through the cloud. This can enable access to the user interface 114 across multiple controllers 108, or by multiple users at various access points. In some examples, the user interface 114 can be accessed through an external network 112. The external network 112 can be a firewall and internet service that already exists on-site for the system 100. The external network 112 can enable the controller 108 to be controlled remotely. The user interface 114 can show data from the controller 108 and allow authorized users to enable/disable control and configure certain control parameters.

The system 100 can be an independent system, or components of the system 100 can be incorporated into systems already existing at solar power sites. For example, an existing solar power site can include the inverters 102, the network 110, the external network 112, and the user interface 114, and the system 100 can be incorporated by coupling the various components of an existing solar power site to the controller 108. As an example, the network 110 can be present at a solar power site and can be connected in a network of inverters 102 at the solar power site.

The system 100, including the controller 108, can include additional functionalities that enhance the usability of the system 100 and can provide risk mitigation for the inverters 102. In some examples, the system 100 can determine whether the controller 108 is functional and can determine whether the power limits of each of the inverters 102 are below 100%. The modules 104 can use historic data and simulate control performance to check for instability in the system 100. Additionally, the modules 104 can perform performance analysis to check for any evidence of unstable control. In some examples, the controller 108 can escalate issues to a solar operation and maintenance team and other groups. In some examples, the inverters 102 can include module main switches, which a local operator can set to OFF to block all remote re-enable commands.

The controller 108 can include various checks to ensure the system 100 is operating correctly. For example, the controller 108 can raise an alarm the temperature data from the inverters 102 and/or the modules 104 is high during the winter (when the temperature data is expected to be low) or when production is low. The controller 108 can include logic to identify bad temperature data and raise specific alarms for similar cases. The controller 108 can periodically check to validate if coupled inverters 102 are configured correctly. The controller 108 can disable control and raise an alarm if checks do not pass. The controller 108 can identify protection modules 104 within the inverters 102 and raise an alarm if there is no module 104 providing protection within an inverter 102.

In one or more examples, the controller 108 can communicate with users of the system 100 which parameters the controller 108 writes to, which inverters 102 the controller 108 is controlling, and how to disable the associated inverters 102. In some examples, the system 100 can identify other controllers, such as power plant control (PPC), that can be pre-checked before controller 108 deployment. In some examples, the controller 108 can be added to site documentation such as network diagram, so it is visible to any other control or Supervisory Control and Data Acquisition (SCADA) effort for the site.

In some examples, the controller 108 can use data compression during one or more periods. For example, the controller 108 can be idle for at least some time periods and the controller 108 can use data compression during periods when the controller 108 is idle. This can reduce (or back off) the data rate for the controller 108. In some examples, the controller 108 can constantly monitor the modules 104 for changes in operational parameters of the modules 104. In some examples, the inverter 102 can include a master module that can assist the controller 108 in control of the other modules 104 of the inverter 102. In some examples, the controller 108 can raise an alarm and disable control of the inverter 102 in cases in which a change to the master module occurs that is unrelated to the controller 108 or is made without direction from the controller 108. The controller 108 can be re-enabled by a human operator using an HMI of the controller 108. Additionally, the controller 108 can be configured to enable users to set custom power limits for the inverters 102 that will be adhered to through the controller 108.

Any of the features, components, and/or parts of the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

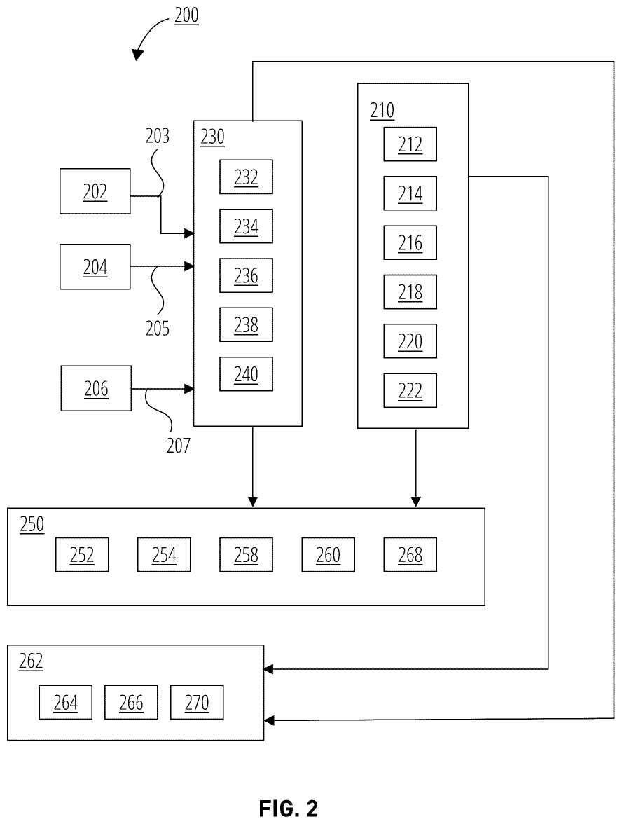

FIG. 2 illustrates control logic 200 that can be used in a system for controlling inverters, such as the system 100 described above with respect to FIG. 1. The control logic 200 can be stored in or can include computer-readable medium, such as computer code, that can be executed by a processor of a computing system. In some examples, the control logic 200 can be used to cause a computing system to perform a method for controlling optimizing inverters. The control logic 200 can be used to calculate and command, for example, power limits, power constraints, temperature setpoints, and module statuses (e.g., enabled or disabled). A controller (e.g., the controller 108, described above with respect to FIG. 1) can use the control logic 200 to control the operation of inverters (e.g., the inverters 102, described above with respect to FIG. 1) and modules of the inverters (e.g., the modules 104, described above with respect to FIG. 1). In some examples, the controller can have other logic related to configuration, population, and validation of data; raising and clearing alarms; data logging; and other operations. The controller can receive inputs from modules and/or inverters, can perform operations of the control logic 200 (e.g., on the inputs), and can output commands to the modules and/or inverters based on the control logic 200.

The control logic 200 can receive input parameters from the modules and/or inverters in a system. The control logic 200 can be implemented in a controller of the system or can interface with the controller of the system. The control logic 200 can include various groups of parameters and blocks. For example, the control logic 200 can include configuration parameters 210, an operation block 230, a calculation block 250, and a module configuration block 262. The configuration parameters 210 can include various parameters that can be specific to modules and/or inverters controlled using the control logic 200. The operation block 230 can perform various operations on data from the modules and/or inverters. The calculation block 250 can perform various calculations on data supplied by the operation block 230 and/or the configuration parameters 210. The module configuration block 262 can receive data from the configuration parameters 210 and the operation block 230 and can perform checks and monitoring on operations performed by other portions of the control logic 200.

Inputs to the control logic 200 can include parameters read from modules and/or inverters coupled to a controller implementing the control logic 200. The parameters can be read from the inverters (e.g., from individual modules of the inverters) at any desired frequency. For example, the parameters can be read from the inverters at each iteration of the control loop, multiple times per iteration of the control loop, or at a frequency less than each iteration of the control loop. The parameters can include various readings. For example, the parameters read can include temperature data 202 (such as temperature data produced by an insulated-gate bipolar transistor (IGBT) temperature sensor or other temperature sensor), power data 204, and error data 206. The temperature data 202 can be supplied in the form of a temperature signal 203. The power data 204 can be supplied in the form of a power signal 205. The error data 206 can be supplied in the form of an error signal 207. Any desired units can be provided for the temperature data 202, the power data 204, and the error data 206, such as degrees Celsius (° C.) for the temperature data 202, kilowatts (kW) for the power data 204, and count for the error data 206. In some examples, the error data 206 can include fault codes for each module of the inverters. In some examples, the error data 206 can use different numbers returned to denote different faults or errors. For example, a value of zero can indicate that no fault or error is active at a specific module. The input parameters can be supplied by the modules and/or inverters and can be received by the control logic 200. The control logic 200 can be part of the controller, such that the input parameters are received by the controller.

In some examples, additional input parameters can be provided to the control logic 200. The additional input parameters can include data related to safety checks performed before writing commands and the like. In some examples, if data read from any of the input parameters fails (e.g., after reasonable retry logic is performed), the data can output a missing value indicator, such as a NaN (not a number) indicator for this data point. This can indicate to a receiving portion of the control logic 200 that the data read has failed and appropriate action can be taken.

In some examples, the input parameters (e.g., the temperature data 202, the power data 204, and the error data 206) can have prescribed ranges of possible or likely values. The prescribed ranges can be provided for each of the inverters or modules connected to the control logic 200 and can be inverter or module specific. If data read in the input parameters is outside the prescribed range, an alarm can be indicated. In response to the alarm, control through the control logic 200 of the inverter and/or module, the module itself, and/or the inverter itself can be disabled.

In some examples, additional input parameters that can be provided to the control logic 200 can include a heartbeat or clock signal. The clock signal can be read at any desired frequency. For example, the clock signal can be read at each iteration of the control loop, multiple times per iteration of the control loop, or at a frequency less than each iteration of the control loop. In some examples, an alarm can be indicated in response to the clock signal returning frozen values (e.g., returning the same value multiple times) for an unacceptable length of time. A frozen clock signal can be indicated when clock signal values are repeated over a period of about 5 seconds, about 10 seconds, about 20 seconds, or about 30 seconds.

The control logic 200 can include configuration parameters 210 for the modules and/or inverters coupled to the control logic 200. In some examples, the configuration parameters 210 can include a rated power 212, an average power 214, a maximum temperature 216, a user-defined maximum power 218, a disabled module list 220, and a maximum error count 222. The configuration parameters 210 can be pre-defined (e.g., based on specific modules and/or inverters coupled to the control logic 200), user-defined, or defined by the control logic 200.

The rated power 212 can be a value for each module and/or inverter that is the maximum power the respective module or inverter is rated to generate. The rated power 212 can be specific to each module or each inverter. In some examples, the rated power 212 for an inverter can be the sum of rated powers 212 for each module included in the inverter. The rated power 212 can be used to convert the average power 214 and/or the user-defined maximum power 218 from a percentage of the rated power 212 to a kW value. The rated power 212 for each module can be, for example, about 100 KW, about 120 kW, about 130 KW, about 135 KW, about 138 kW, about 140 KW, or about 150 KW. In some examples, an allowable range for the rated power 212 for an inverter can be from about 10 KW to about 1000 kW. However, modules and inverters can have varying values for the rated power 212, and the teachings of the present disclosure can be applied to any modules and/or inverters. The rated power 212 can be a pre-defined value based on the modules and/or inverters coupled to the control logic 200.

The average power 214 can be an average power generated by each of the modules and/or inverters. The average power 214 is generally less than the rated power 212. In other words, the modules and/or inverters generally operate at less than their rated power 212 and can generate less power than a theoretical maximum power. In examples in which a rated power 212 for a module is about 138 kW, a typical value for the average power 214 can be about 125 kW. In some examples, an allowable range for the average power 214 for an inverter can be from about 10 KW to about 1000 kW. The average power 214 can be derived, calculated, or defined by the control logic 200 based on the power data 204 received by the control logic 200 over time. In some examples, the average power 214 can be defined as a percentage value, such as a percentage of the rated power 212. For example, the average power 214 can be about 95%, about 92.5%, about 90%, about 85%, about 80%, or about 75% of the rated power 212.

The maximum temperature 216 can be a temperature value (e.g., in degrees Celsius) that is below a temperature at which the modules and/or inverters will fault, trip, or overheat. A power limit can be set by the control logic 200 in order to maintain the temperatures of the modules and/or inverters below the maximum temperature 216. In other words, as temperatures of the modules and/or inverters increase, the control logic 200 can be applied by the controller to lower the power limit at the module and/or inverter to maintain the module and/or inverter temperatures (represented by the temperature data temperature data 202) below the maximum temperature 216. The control logic 200 can also be applied by the controller to disable one or more modules of an inverter to maintain the module and/or inverter temperatures below the maximum temperature 216. In some examples, the maximum temperature 216 can be set based on balancing production loss caused by limiting the power limit and/or disabling the modules against potential errors, faults, circuit tripping, and overheating experienced by the modules and/or inverters. The maximum temperature 216 can be about 90° C., about 95° C., about 100° C., about 105° C., about 110° C., or another suitable value. The maximum temperature 216 can depend on maximum operating temperatures of the modules and/or inverters coupled to the control logic 200. In some examples, the maximum temperature 216 can be in a range from about 90° C. to about 115° C., from about 90° C. to about 95° C., from about 95° C. to about 105° C., from about 100° C. to about 110° C., or another suitable range. In some examples, the modules and/or inverters can generate errors, faults, overheating, or can trip at a threshold temperature of about 105° C., about 110° C., about 115° C., or about 120° C. The maximum temperature 216 can be a prescribed value under this threshold temperature, such as about 2° C., about 5° C., about 10° C., within a range from about 2° C. to about 10° C., or the like under the threshold temperature. In some examples, an alert or error can be generated if the maximum temperature 216 is not at least about 2° C. to about 10° C. below the threshold temperature. Further, errors reflected in the error data 206 can be generated when temperatures reflected in the temperature data 202 are above the maximum temperature 216.

The user-defined maximum power 218 can be a desired module and/or inverter power limit with no temperature curtailment. Use of the user-defined maximum power 218 can enable users to apply curtailment unrelated to temperature, while keeping temperature control enabled. In some examples, the user-defined maximum power 218 can be defined as a percentage value, such as a percentage of the rated power 212. For example, a user can use the user-defined maximum power 218 to set power generation to generate less than 100% of the rated power 212, even if the power limit and/or the maximum temperature 216 are not met. This value can be 100% by default and can be set anywhere from 0% (power generation is ceased) to 100% of the rated power 212.

The disabled module list 220 can be a list of modules that are currently disabled, set to be disable, and/or should not be re-enabled by the controller. Use of the disabled module list 220 can enable users and/or the control logic 200 to disable modules for any reason, while keeping temperature control enabled for the modules and/or inverters. For example, a module can be disabled and added to the disabled module list 220 by the control logic 200 in response to an error count in the error data 206 of the module reaching a threshold value. The threshold value can indicate that the module requires repair. Similarly, a user can add a module to the disabled module list 220 while repairs or maintenance are being performed on the module, or for any other desired reason. Although the disabled module list 220 is described as a disabled module list, groups of modules, inverters, or groups of inverters can be added to the disabled module list 220 the same as or similarly to the modules.

The maximum error count 222 can be an error count after which a module or inverter is disabled. In some examples, the maximum error count 222 can be a daily error count (e.g., the maximum error count 222 can be reset on a daily basis), a rolling error count, a seasonal error count, or can be based on or reset according to any other desirable timeline. In some examples, the controller can temporarily disable a module or inverter if the error data 206 for the module or inverter reaches the maximum error count 222. In some examples, the maximum error count 222 can function in conjunction with the disabled module list 220. For example, a module or inverter can be added to the disabled module list 220 if the error data 206 for the module or inverter reaches the maximum error count 222. The maximum error count 222 can be a daily error count, and can be set at a value of 1, 2, 3, 4, 5, in a range from 1 to 10, or any other suitable value.

The operation block 230 can perform various operations on data from the modules and/or inverters, such as the temperature data temperature data 202 supplied by the temperature signal 203, the power data 204 supplied by the power signal 205, and the error data 206 supplied by the error signal 207. The operations performed at the operation block 230 can include collecting, summarizing, performing calculations on, characterizing, and other operations or calculations. The operation block 230 can include a generating block 232, a temperature block 234, a power block 236, a number generating block 238, and an error block 240. The blocks of the operation block 230 can output lists based on the temperature data 202 supplied by the temperature signal 203, the power data 204 supplied by the power signal 205, and the error data 206 supplied by the error signal 207. In some examples, the temperature data 202 supplied by the temperature signal 203, the power data 204 supplied by the power signal 205, and the error data 206 supplied by the error signal 207 can be directly supplied to calculation blocks of the control logic 200 without operations of the operation block 230 being performed on the data and signals.

The generating block 232 can output a list of modules and/or inverters considered to be online for purposes of temperature control. The generating block 232 can determine whether a module or inverter is online based on power generated in each module or inverter. This can be represented by the power data 204 in the power signal 205. In some examples, a module or inverter can be determined to be online if power generated in the module or inverter is above a threshold value. The threshold value can be, for example, about 500 W, about 700 W, about 1 kW, about 1.2 kW, or any other desired or appropriate value.

The temperature block 234 can output a list of temperatures for each of the generating modules and/or inverters included in the output of the generating block 232. In some examples, the temperature block 234 can also output temperatures for modules and/or inverters that are not considered online and are not included in the output of the generating block 232. The temperature block 234 can output NaN temperatures in cases where temperature readings for a generating module or inverter have failed. The temperatures output from the temperature block 234 can be based on the temperature data 202 in the temperature signal 203 and/or the generating block 232.

The power block 236 can output a list of power data for each of the generating modules and/or inverters included in the output of the generating block 232. In some examples, the power block 236 can also output power data for modules or inverters that are not considered online and are not included in the output of the generating block 232. For example, the power data for modules or inverters that are not online can be zero or another value less than the threshold value to be considered online. In some examples, the power block 236 can output NaN power data in cases where power readings for a generating module or inverter have failed. The power data output from the power block 236 can be based on the power data 204 in the power signal 205 and/or the generating block 232.

The number generating block 238 can include a count or a number of the generating modules or inverters included in the output of the generating block 232. The number generating block 238 can be based on the power data 204 in the power signal 205 and/or the generating block 232.

The error block 240 can output a number of errors, faults, trips, and/or instances of overheating that have occurred over a period of time. In some examples, the error block 240 can output the errors that occur in the modules and/or inverters included in the output of the generating block 232. In some examples, the error block 240 can also output error data for modules or inverters that are not considered online and are not included in the output of the generating block 232. As an example, the error block 240 can output the number of errors that occur in one day. The error block 240 can output the number of errors in any desired time period. The data in the error block 240 can be reset at certain times or can include a rolling number (e.g., the number of errors in the past 12 hours). The number of errors output from the error block 240 can be based on the error data 206 in the error signal 207 and/or the generating block 232.

In some examples, the control logic 200 can include a calculation block 250, which can perform various calculations on data supplied by the operation block 230, the input parameters, and/or the configuration parameters 210. In some examples, the operation block 230 can be omitted and the calculation block 250 can perform calculations based on the input parameters and/or the configuration parameters 210. The calculation block 250 can include a power limit block 252, a curtailment limit block 254, a power limit curtailment block 258, a power limit safety check block 260, and a power limit command block 268.

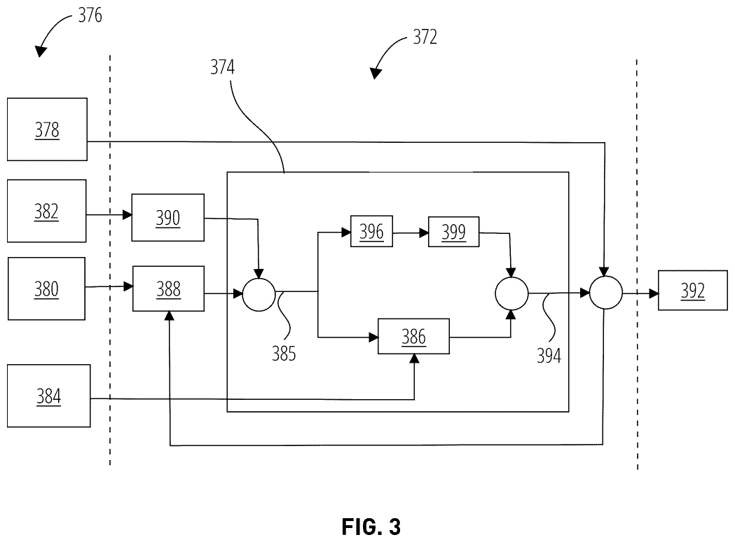

The power limit block 252 can be the main control algorithm or operation of the control logic 200. Additional details for the power limit block 252 are discussed below with respect to FIG. 3. In some examples, the power limit block 252 can output a power limit for each module and/or inverter between 0% (e.g. disabling the module or inverter) and 100% (e.g., providing no temperature curtailment to the module or inverter). The power limit supplied by the power limit block 252 can be a percentage of the rated power 212 for each module or inverter. In some examples, the output of the power limit block 252 can be NaN, such as in cases in which input data is missing. In cases in which there is insufficient input data to determine an output of the power limit block 252, the power limit can be set to disable the module or inverter in question and/or an alarm or alert can be generated and sent to the user. In some examples, a default output of the power limit block 252 can be 100%, meaning that no temperature curtailment is provided to a module and/or inverter and the module and/or inverter operates at the rated power 212.

The curtailment limit block 254 can output a limit for module and/or inverter curtailment. In other words, the curtailment limit block 254 can set a lower limit for how low the power limit block 252 is able to limit the power generation for the modules and/or inverters. The curtailment limit block 254 can determine a lower limit based on risk of power generation being interrupted and potential power loss based on the interruptions.

Specifically, the curtailment limit block 254 can calculate how many modules are at risk of experiencing an error, fault, circuit trip, or overheating and how much potential power loss these errors could cause. The risk of the modules experiencing errors can be determined from the temperature data 202 for each of the modules. Higher temperatures indicate a higher risk of the modules experiencing an error. The potential power loss caused by the errors can be proportional to each respective module's average power 214. In some examples, the output of the curtailment limit block 254 is a percentage limit that can be applied to the power limit of the power limit block 252. The lower limit of the curtailment limit block 254 can be a power limit for each module and/or inverter between 0% (allowing for maximum temperature curtailment) and 100% (allowing for no temperature curtailment). In other words, when the power limit block 252 determines that there will be some curtailment of power generation and the power limit is less than 100%, the lower limit of the curtailment limit block 254 can reduce the curtailment and can be used to raise the power limit closer to 100%. In some examples, the lower limit for the inverter can be based on potential power loss from risk of the power inverter components becoming inoperative. In some examples, the power limit supplied to a module or an inverter by the control logic 200 can be adjusted to the greater of the calculated power limit (from the power limit block 252) or the lower limit (from the curtailment limit block 254).

The curtailment limit block 254 can be used to prevent the control logic from applying a power limit that is lower than the likely loss due to errors (and interruptions) occurring in the modules and/or the inverters. For example, in an inverter that includes 10 modules with one hot module, only the hot module is at risk of an error. A likely power loss due to an error is about 10%. In some examples, the likely power loss can be closer to 2%, as an error can cause temporary, rather than permanent, downtime. If the power limit block 252 were to reduce power generation by 20% (e.g., set an 80% power limit) to prevent an error from occurring in the single hot module, then more power would be lost than is necessary. As such, the curtailment limit block 254 can calculate and apply a lower limit to reduce curtailment by the power limit block 252 and increase the power limit applied to the modules and/or inverters.

The error loss prediction of the curtailment limit block 254 can be calculated for each module and/or inverter. For example, the error loss prediction can be calculated according to the following equation:

$$Error loss prediction = Error loss probability ⋆ Average power ⋆ Downtime factor$$

The error loss probability can be zero for a module or inverter that is offline or has a temperature that is less than a maximum allowable temperature (e.g., the maximum temperature 216) by greater than a prescribed margin. For example, the error loss probability can be zero for a module or inverter that has a temperature that is less than the maximum allowable temperature by greater than about 15° C., greater than about 10° C., or greater than about 5° C. The error loss probability can be greater as the temperature of a module or inverter approaches the maximum allowable temperature. The average power can be the average power 214 for each respective module or inverter. The downtime factor can represent a typical downtime caused by an error experienced by a module. For example, the downtime factor can represent a typical time period that a module is down when the module experiences an error. The downtime factor can be, for example, about 5%, about 10%, about 15%, about 20%, or about 25%. In this manner, the power lower limit is calculated by the curtailment limit block 254 based on various temperature data, power data received from inverters and associated components, and a downtime factor.

The total error loss prediction for an inverter can be a sum of the error loss prediction for each module included in the inverter. In some examples, a low pass filter can be applied to the total error loss predictions for the inverters. A “backlash” term for the inverters can be calculated according to the following equation:

$$Backlash = 1 - \sum Average power / \sum Rated power$$

The average power can be the average power 214 for each of the modules of an inverter. The rated power can be the rated power 212 for each of the modules of the inverter. In some examples, the rated power sum can include all of the modules in an inverter regardless of generating status in the generating block 232. The backlash can represent the percentage of the rated power for an inverter that is lost in operation of the inverter. In some examples, the average power 214 used to calculate the backlash can include the generating modules of the generating block 232, without including non-generating modules or offline modules.

In some examples, a maximum curtailment for an inverter can be calculated according to the following equation:

$$Maximum curtailment = \frac{\sum Error loss prediction}{\sum Rated power}$$

The error loss prediction can be calculated for each module in an inverter according to the above equation. In some examples, the error loss prediction used to calculate the maximum curtailment can include the generating modules of generating block 232, without including non-generating modules or offline modules. The rated power can be the rated power 212 for each of the modules of the inverter. In some examples, the rated power sum can include all of the modules in the inverter regardless of generating status in the generating block 232. According to the above equations, the curtailment limit block 254 can calculate a lower limit for power curtailment, which can ensure that inverters are minimally curtailed to maximize power generation.

In cases in which a block of the control logic 200 outputs a NaN output, various operations can be performed to correct for the NaN output. For example, when a NaN is output by the operation block 230 or is read as an input from the temperature data 202, the power data 204, or the error data 206, the calculation block 250 can use a previous data reading from one or more of the modules and/or inverters as the NaN. In cases where the temperature output by the operation block 230 is a NaN, the calculation block 250 can use a previous temperature reading from the module. In some examples, when the calculation block 250 uses a previous temperature reading from the modules, the calculation block 250 can alter the previous temperature reading to adjust for time since the previous reading was taken. For example, the calculation block 250 can increase the previous temperature reading of the modules to account for time. In some examples, the calculation block 250 can increase the previous temperature by 0.5, 1, or 2° C./s since the previous reading. In some examples, the calculation block 250 can also adjust the temperature output of the operation block 230 in the event of a NaN output based on season, weather patterns, and/or relevant temperature trends. If there is no previous good temperature reading, the calculation block 250 can consider the module to be at risk of a fault. The calculation block 250 can report an error when there is not a previous temperature reading on which to base an adjusted NaN.

Similarly, in examples where an NaN output involves a power output, the calculation block 250 can use a previous power reading from the module to calculate power limits and other functions of the control logic 200. In some examples, the calculation block 250 can take the last good, (e.g. non-NaN) power reading from the module and increase it to account for the time since the last good power reading. In at least one example, the calculation block 250 can increase a previous power reading by 1, 2, 5, or the like kW/s. In some examples, the calculation block 250 can increase the previous power reading up to the maximum power the modules are rated for. In cases where there is no previous good power reading, the calculation block 250 can use the rated power 212 for the respective module.

If there are no generating modules, or no modules that are currently reporting to the controller, previous values of the power limit, the lower limit, and/or power curtailment can be used in calculations performed by the calculation block 250 of the control logic 200. In some examples, if there is no previous power limit calculation, then the output of the power limit calculation calculated by the calculation block 250 can be a NaN output. In this example, an error can be sent to the controller. In cases in which a NaN is output for the power limit, the modules and/or inverters can operate at 100% power generation (0% power curtailment).

In some examples, the calculated power limit calculated by the power limit block 252 can be in a range bounded by a lower limit (e.g., greater than zero) and an upper limit of 100%. The power limit calculated by the power limit block 252 can be inside the range 2%-100%, where 100% is the power that a module is rated for (e.g., the rated power 212). The power limit calculated by the power limit block 252 can be a NaN if the calculated power limit is outside the range defined between the lower limit and the upper limit. The lower limit of the range of the power limit can be above 0%. The lower limit of the power limit for each module can be a non-zero value. This ensures that the temperature curtailment based on the power limit can avoid making a module appear to be offline. In this manner, the controller can read what state a module is in, even if it is disabled.

In some examples, the power limit calculated by the power limit block 252 can exceed the lower limit calculated by the calculation block 250. If the power limit is output as NaN, then power limit can be changed to NaN value. In some examples, the lower limit described above can be calculated by the following equation:

$$Lower Limit = 100 \% - Max Curtailment - Max ( Backlash , 100 \% - Max Power Limit )$$

In this and the above equations, the Max Power Limit can be a configuration setting, and the max( ) function can help ensure that a Max Power Limit below 100% can use any available backlash before affecting the Lower Limit. In some examples, the Lower Limit is rate-limited to prevent a sudden change for any reason. This can prevent the power limit command from dipping too low too quickly.

In some examples, the calculation block 250 can include a power limit curtailment block 258. The power limit curtailment block 258 can be configured to apply limits to the calculated power limit calculated by the calculation block 250 (e.g., the power limit block 252 and/or the curtailment limit block 254). In other words, the power limit curtailment block 258 can increase the power limit applied to modules and/or inverters. If a power limit is applied to one or more of the calculations via the power limit curtailment block 258, this new limit is passed back into the power limit block 252 so a new calculation of the power limit can be accomplished. In some examples, the use of a power limit curtailment block 258 can help prevent integrator wind up. For example, enforcing a constraint on the power limit calculated by the calculation block 250 can enable the controller to decrease the time needed to respond to errors caused by overheating.

The power limit curtailment block 258 can ensure that the power limit is within the range bounded by the lower limit and the upper limit. The power limit curtailment block 258 can limit the rate of change of the power limit calculated in calculation block 250. The power limit can change at a variable rate of change. The rate of change for the power limit can be fixed or can be limited under a power limit rate threshold. In some examples, this power limit rate threshold can be, for example, 1%, 2%, 3%, or 5% of the rated power 212 for a respective module per second. The power limit curtailment block 258 can ensure that the power limit applied to the modules and/or inverters is not less than the power limit lower limit.

In some examples, the calculation block 250 can include a power limit safety check block 260. The power limit safety check block 260 can perform various checks on the power limits of the calculation block 250 and raise alarms and/or disable control by the control logic 200 if the checks fail. The power limit safety check block 260 can determine whether a single module in each group of modules is identified as a master module that is under control by the control logic 200. The power limit safety check block 260 can determine whether power limits supplied to the modules and/or inverters based on the power limit block 252 and/or the curtailment limit block 254 have been properly commanded to the modules and/or inverters. The power limit safety check block 260 can raise alarms and/or disable control by the control logic 200 if the power limits are incorrectly written a prescribed number of times (e.g., more than once, more than twice, more than 3 times, or the like in a given period). The power limit safety check block 260 can determine whether power limits supplied to the modules and/or inverters based on the power limit block 252 and/or the curtailment limit block 254 are being obeyed by the modules and/or inverters. The power limit safety check block 260 can raise alarms and/or disable control by the control logic 200 if the power limits are not obeyed within a prescribed tolerance, such as 0.1 kW, 0.5 KW, 1 KW, 1.5 KW, or another suitable tolerance. The power limit safety check block 260 can send an error to the controller and disable control of one or more components of the system if any of the components of the system are pulling an undesirable amount of power. In at least one example, the power limit safety check block 260 can calculate when an inverter, a module, or the system as a whole should be disabled. In this manner, the control logic 200 can further protect the system against harmful power surges and overheating of different inverters. In at least one example, the power limit safety check block 260 can output an error and disable one or more of the components of the system if the difference between total power of a module and one kW is greater than the total rated power of a select module multiplied by the AC power limit of the system.

In some examples, the calculation block 250 can include a power limit command block 268. The power limit command block 268 can convert the calculations of the calculation block 250 into parameters and commands that can be written to components of a system, such as modules, inverters, or controllers in a power generation system. The control logic 200 can convert calculated power limits (e.g., by the power limit block 252 and/or the curtailment limit block 254) to a Modbus scale or another suitable format so that commands can be sent from the control logic 200 to modules, inverters, and/or controllers. In cases where a NaN power limit is calculated, the control logic 200 can prevent write commands from being attempted. If a command write fails (e.g. after reasonable retry logic), this information can be fed back to the calculation block 250 for additional safety checks. In some examples, the control logic 200 can write directly to the modules, inverters, and/or controllers if the values to be written are different from the current values that have been calculated and/or output by the calculation block 250.

The control logic 200 can further include a module configuration block 262. The module configuration block 262 can receive data from the input parameters, the configuration parameters 210, and/or the operation block 230. The module configuration block 262 can check previous calculations, operations, and data for errors. For example, the module configuration block 262 can detect an error in a module if the module was disabled and remained disabled, without being on a do not enable list of the configuration parameters 210.

The module configuration block 262 determine whether a master module is identified for each group of modules. The module configuration block 262 can ensure that modules to be disabled are not the master module of a group of modules. The module configuration block 262 can determine whether modules are obeying previous disable or enable commands. The module configuration block 262 can determine whether there is a single master module in each group of modules and whether the master module is generating power. When an enable command is provided for a module, the module configuration block 262 can determine whether the module or the module group has been generating power since the module was disabled. The module configuration block 262 can determine whether switches within modules in the inverters are activated. If a main switch in any module is not activated, the module configuration block 262 can raise an error and disable control for the inverter including the respective module.

The module configuration block 262 can include a module disable/enable block 264, a module safety check block 266, and a module command block 270. The module disable/enable block 264 can include a control algorithm responsible for deciding when to disable and enable modules. The module disable/enable block 264 can disable and enable modules based on a number of error occurrences that have occurred in the respective module (e.g., based on the error data 206). When a module reaches a high temperature, this can result in an error that can be counted by the module configuration block 262. The module configuration block 262 can define a maximum number of times a module can send this error during a set duration. If a module surpasses this maximum number of errors within the set duration (e.g. due to the module consistently reaching high temperatures), the module disable/enable block 264 can disable the module. In this manner, the control logic 200 can account for and disable modules that are overheating and decreasing the efficiency of the inverters. In some examples, the module disable/enable block 264 can disable modules for a short wait time (e.g., 1 minute, 2 minutes, or 5 minutes). In some examples, the module can be enabled by the module disable/enable block 264 when the risk of a temperature-induced error is low enough to avoid further overheating.

The module safety check block 266 can determine whether modules and/or inverters should be enabled or disabled. The controller can enable a module if the module safety check block 266 is active. The module safety check block 266 can raise alarms and cancel commands to change the status of a module if any of the checks fail. The checks can include: determining whether a master module is identified and whether a disabled module is not the master module; determining whether all modules are obeying previous disable/enable commands; determining whether a single master module in a group of modules is under control and is generating power; for a module with an enable command, determining whether a module group including the module has been generating since the module was disabled; and for a module with an enable command, determining a status of a main switch for modules of an inverter.

In one or more examples, the module configuration block 262 can include a module command block 270. The module command block 270 can convert the calculations of the module configuration block 262 and/or the calculation block 250 into parameters and commands that can be written to components of a system, such as modules, inverters, or controllers in a power generation system. The control logic 200 can convert the calculated power limit to a Modbus scale or another suitable format so that commands can be sent from the control logic 200 to modules, inverters, and/or controllers. In cases where a NaN power limit is calculated, the control logic 200 can prevent write commands from being attempted. If a command write fails (e.g. after reasonable retry logic), this information can be fed back to the calculation block 250 for additional safety checks. In some examples, the control logic 200 can write directly to the modules, inverters, and/or controllers if the values to be written are different from the current values that have been calculated and/or output by the module configuration block 262.

The control logic 200 can be implemented as a control loop. In other words, the control logic 200 can include a series of commands that are repeated in a loop. Each loop of the control logic 200 can iterate for a select or prescribed length of time. For example, each iteration of the control loop can iterate for a period of about 1 second, about 5 seconds, about 10 seconds, about 15 seconds, about 20 seconds, or about 30 seconds. In some examples, the control loop can iterate for variable time periods. For example, during normal operation, the control loop can iterate for a relatively long time period (e.g., about 10 seconds or longer). When conditions are such that modules or inverters are more likely to overheat (e.g., a local ambient temperature is high, modules or inverters have begun to have errors or overheat, or the like), the control loop can iterate for a relatively short time period (e.g., about 10 seconds or less).

In some examples, modules, groups of modules, inverters, and/or groups of inverters can include default controls. This can be used to perform control operations for the modules and/or inverters even when the control logic 200 is disabled or disconnected from the modules and/or inverters. In some examples, a user of a system (e.g., the system 100 described above with respect to FIG. 1) can enable or disable control for the modules, groups of modules, inverters, and/or groups of inverters by the control logic 200. In some examples, the modules of the inverters can be grouped (e.g., FIG. 1 illustrates a group of modules in an inverter), and each group of modules can include a master module and a common bus. Each group of modules can be controlled through the master module. When control of the modules or inverters through the control logic 200 is disabled, a notification can be sent to users of the control logic 200 reporting that control has been disabled. The notification can detail the current value of the power limit for each inverter and provide notifications for any specific modules that are disabled.

In cases when control of modules and/or inverters through the control logic 200 is disabled, a default power limit can be set for each of the inverters. In some examples, the default power limit can be referred to as a “maximum power limit.” The default power limit can be 100%. The default power limit can be set to a maximum value in order to maximize potential power generation. The default power limit can be set lower than 100%, such as about 95%, about 90%, about 85%, about 80%. This can prevent overheating, tripping, faults, and the like in the modules and inverters, while still providing relatively high-power generation.

In some examples, the default power limit can vary seasonally or can vary based on conditions most recently reported in the modules and/or inverters. For example, the default power limit can be set higher in cold seasons and lower in hot seasons so as to more effectively manage the temperature of the modules and the inverters. The default power limit can be the power limit that was most recently applied to each of the modules or inverters through the control logic 200. The default power limit can be set for modules and/or inverters based on a difference between a maximum module temperature and a most recently reported module temperature.

Any of the features, components, and/or parts, of the arrangements and configurations thereof shown in FIG. 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2.

FIG. 3 illustrates a block diagram of a power limit calculation 372. The power limit calculation 372 can be performed as the calculations or operations performed by the power limit block 252, discussed above in reference to FIG. 2. The power limit calculation 372 can be or include codable instructions stored on a non-transitory computer-readable medium. The power limit calculation 372 can be executed by a processor of a computing system. The power limit calculation 372 can be performed as part of a method for optimizing performance of an inverter and can be performed by a controller commanding an inverter.

The power limit calculation 372 can be implemented by a controller 374. FIG. 3 illustrates an example of a proportional-integral-derivative (PID) controller 374. However, the controller 374 can include any combination of proportional, integral, and derivative controllers. For example, the controller 374 can include a proportional (P) controller, an integral (I) controller, a derivative (D) controller, a proportional-integral (PI) controller, a proportional-derivative (PD) controller, or a PID controller. In examples in which the controller 374 is a P, I, D, PI, or PD controller, one or more operations illustrated in FIG. 3 can be omitted.

Generally, inputs 376 can be provided to the power limit calculation 372, the power limit calculation 372 can perform operations on the inputs 376, and the power limit calculation 372 can produce a power limit 392 as an output. The inputs 376 received by the power limit calculation 372 can include a configured maximum power limit 378, a maximum allowed temperature 380, a generating module temperature 382, and a power limit command 384. The configured maximum power limit 378 can be a desired power limit that does not include power curtailment. In other words, the configured maximum power limit 378 can be a default power limit before power curtailment is calculated. The configured maximum power limit 378 can be input into or received by the power limit calculation 372 from a module, an inverter, a controller, or a user.

The maximum allowed temperature 380 can be a desired maximum temperature of the modules and/or inverters. The maximum allowed temperature 380 can be the same as or similar to the maximum temperature 216, discussed above with respect to FIG. 2. The maximum allowed temperature 380 can be input into or received by the power limit calculation 372 from a module, an inverter, a controller, or a user.

The generating module temperature 382 can be a current temperature of a module and/or inverter (e.g., each generating module and/or inverter connected to the power limit calculation 372). The generating module temperature 382 can be based on the temperature data 202, discussed above with respect to FIG. 2. The generating module temperature 382 can be input into or received by the power limit calculation 372 from a module, an inverter, a controller, or a user.

The power limit command 384 can be a Modbus or other format command that can be used in the power limit calculation 372. The power limit command 384 can assist the controller 374 in writing commands to various components of the system. In some examples, when the power limit command 384 differs from the output of the power limit calculation 372, the power limit calculation 372 can adjust an integral (I) term 386 of the controller 374. In at least one example, this alteration of the I term 386 can prevent wind up in the system.

The power limit calculation 372 can maximize calculated power limits, while controlling the temperatures of associated modules and/or inverters. For example, the power limit calculation 372 can set the power limit 392 in order to control a maximum temperature 390 of the modules and/or inverters.

The power limit calculation 372 can calculate the maximum temperature setpoint 388 and the maximum temperature 390 for each of the modules and/or inverters. The maximum temperature setpoint 388 can be determined from the maximum allowed temperature 380. The maximum temperature setpoint 388 can be based on modules or other components of an inverter. In some examples, the modules and/or inverters can be initialized at a temperature start point that is lower than the maximum temperature setpoint 388 by a prescribed value. For example, the maximum temperature setpoint 388 can initially be set to less than the maximum allowed temperature 380 by a threshold value such as, for example, 15, 12, 10, 8, 6, or 5° C. The power limit calculation 372 can then raise the maximum temperature setpoint 388 closer to the maximum allowed temperature 380 as the modules and/or inverters operate and generate data. The difference between the maximum temperature setpoint 388 and the maximum allowed temperature 380 can help to prevent overshooting the maximum temperature setpoint 388 and further avoid overheating. The maximum temperature 390 can be determined based on the generating module temperature 382 and is the maximum temperature value for the generating modules.

The power limit calculation 372 can alter the maximum temperature setpoint 388 based on the maximum temperature 390. For example, the power limit calculation 372 can raise the maximum temperature setpoint 388 if the maximum temperature 390 exceeds the maximum temperature setpoint 388. The maximum temperature setpoint 388 can be raised proportional to a curtailment factor 394 using the equation:

$$Maximum Temperature Setpoint = Last Maximim Temperature Setpoint + ( \frac{Curt a i l m e n t}{5} ) * Loop Time$$

The maximum temperature setpoint 388 can be raised towards a maximum value of the maximum allowed temperature 380. If the curtailment factor 394 decreases to zero, the maximum temperature setpoint 388 can be gradually lowered to the initial value (e.g., the maximum allowed temperature 380 minus the threshold value). The maximum allowed temperature 380 can change slowly in order to avoid instability in the controller 374.

In some examples, the power limit calculation 372 can modify the start point for the maximum temperature setpoint 388 relatively far from the maximum allowed temperature 380. The maximum temperature setpoint 388 can be configured to start relatively far from the maximum allowed temperature 380 and adjust upward over time to maximize power generated by the system, while minimizing downtime and maintenance.

In some examples, the controller 374 can receive inputs including the inputs 376, the maximum temperature 390, the maximum temperature setpoint 388, and the power limit command 384. The controller 374 can use this data to calculate a power limit 392. The power limit 392 can limit how much power is generated by modules and/or inverters, which can be used to adjust the temperatures of the modules and/or inverters. The power limit 392 can be an overall power limit for an inverter, which controls the percentage of rated power each module operates at. The power limit 392 can be a power limit for an inverter that specifies which and/or how many modules of the inverter are to be disabled. The power limit 392 can selectively limit power generated by modules and/or inverters or disable modules or other components of an inverter in order to control the temperatures of the modules and/or inverters. In some examples, the power limit 392 can be used to intelligently and selectively disable one or more of the components or modules within an inverter to maintain the current temperature of the inverter below the maximum temperature setpoint 388.

Systems utilizing the power limit calculation 372 can have relatively long time constants, which allows the system to respond slowly to control action regarding the power limit 392. For example, once the power limit 392 is calculated, a system (e.g., a module, an inverter, and/or a controller) can be configured to reach the maximum temperature setpoint 388 slowly. This maximizes power output through the process of power generation as the modules and/or inverters heat up.

The controller 374 can control the maximum temperature 390 by adjusting the power limit 392 and the maximum temperature setpoint 388 of the modules and/or inverters. By increasing the maximum temperature setpoint 388, the controller 374 can increase the power limit 392 and vice versa. The maximum temperature setpoint 388 can be a dynamic value that can be controlled by the controller 374. As an example of operation of the power limit calculation 372, the controller 374 can initially set the maximum temperature setpoint 388 10° C. lower than the maximum allowed temperature 380. For example, if the maximum allowed temperature 380 is 100° C., the controller 374 can set the initial maximum temperature setpoint 388 to 90° C. The maximum allowed temperature 380 and the threshold value can be configurable values that can be adjusted in accordance with environment and other efficiency factors. The maximum allowed temperature 380 can be a characteristic of modules and/or inverters. In some examples, the threshold value can be a percentage, such as 2%, 5%, 8%, or 10% of the maximum allowed temperature 380.

In some examples, the maximum temperature setpoint 388 can be increased in proportion to the curtailment factor 394 computed by a previous loop of the controller 374. The maximum temperature setpoint 388 can be increased up to the maximum allowed temperature 380. In some examples, once the curtailment factor 394 drops to zero (e.g. because power generation by the modules and/or inverters has decreased, the ambient temperature is low, or the like), the maximum temperature setpoint 388 can be decreased over time to the initial value, such as 90 degrees Celsius in the above example. In other words, the maximum temperature setpoint 388 can be decreased to an initial or starting value, which can be the threshold value less than the maximum allowed temperature 380.

In some examples, the controller 374 can include a Low-Pass Filter (LPF) 396. The LPF 396 can be beneficial where the power limit command 384 received by the controller 374 has significant noise and quantization error. In some examples, the LPF 396 can protect the integrity of the signals used and calculated by the controller 374 in the power limit calculation 372. In some examples, the controller 374 can include a proportional (P) term 399 and an integral (I) term 386 for calculating the power limit 392. The P term 399 can be protected from errors by applying the LPF 396 to data before calculating the P term 399. In some examples, the LPF 396 can have varying time constants. In some examples, the time constant of the LPF 396 can be 15 seconds, 9.5 seconds, 5 seconds, or the like.

The controller 374 can calculate the P term 399. The controller 374 can calculate the P term 399 according to the equation:

$$P term = Max ( 0 , kp , * ( LPF Error - 1 degC ) )$$

Where kp is a tunable constant and error_lpf is the output of the LPF 396. The max function results in the P term 399 being zero when error_lpf is below 1° C. (indicating one-sided control). The P term 399 linearly increases when error_lpf is 1° C. or greater. The terms of the P term equation can be adjusted based on noise. For example, 1° C. can be used instead of 0° C. because of the noise and 1° C. quantization error in the generating module temperature 382.

The controller 374 can calculate the I term 386. The controller 374 can calculate the I term 386 according to the equation:

$$I Term = max ( 0 , Loop Time * ki * max ( - 1 degC , Erro r ) + Last I Term$$

Where the Loop Time is the control loop time in seconds, ki is a tunable constant and the Last I Term is the I term 386 from the previous loop. In some examples, the first max function results in the I term 386 being unable to be negative (e.g. with one-sided control). The second max function can prevent the I term 386 from winding down too quickly in cases where the maximum temperature 390 decreases rapidly. If the power limit command 384 is different from the output power limit 392 (e.g. because of clipping), the controller 374 can adjust the I term 386 to be consistent with the power limit command 384. In some examples, this can further prevent integrator wind up.

In some examples, the curtailment factor 394 can be determined based on data filtered through the LPF 396. As shown in FIG. 3, the curtailment factor 394 can be defined by combining the P term 399 and the I term 386. In this manner, the curtailment factor 394 can be calculated based on the generating module temperature 382. In other words, the curtailment factor 394 can be determined based on the current temperature of modules and/or inverters.

In some examples, the power limit calculation 372 can output a power limit 392. In some examples, the power limit calculation can transform the curtailment factor 394 to a power limit value. This can be output in a format expected by an associated Modbus or other network device. The power limit 392 can be calculated according to the following equation:

$$Power limit = Max ( 0 \% , Min ( 100 \% , 100 \% ⋆ ( Max Power Limit - Curtailment )$$

Where the calculated power limit can be 100%—curtailment and clipped to stay in the range 0% to 100%. Alternative implementations for the power limit calculation 372 can use any type of controller, such as a P, I, D, PI, PD, or PID controller, including any associated terms and/or operations. In some examples, the power limit calculation 372 can be accomplished via model predictive control (MPC). In some examples, the power limit calculation 372 can be further configured to mitigate risks due to sub-optimal output via upstream blocks and power limit 392 constraints as defined in FIG. 2 above. In some examples, the power limit 392 can be calculated in part based on the curtailment factor 394. In this manner, the power limit 392 can be based at least in part on a difference between the maximum power limit and the curtailment factor 394.

In some examples, as the controller 374 iterates through this process of temperature regulation, the temperature start point of a module and/or inverter can be adjusted to the current temperature, or the generating module temperature 382, based on the curtailment factor 394, with each iteration. This can enable the controller 374 to adjust the power limit 392 based on current factors affecting the temperatures of the modules and/or inverters in real time. Furthermore, the maximum temperature setpoint 388 can be adjusted as modules and/or inverters heat up. In one or more examples, the maximum temperature setpoint 388 can be adjusted in part based on the curtailment factor 394. This can further increase the efficiency of the modules and/or inverters in that the next maximum temperature setpoint 388 can be determined in accordance with the specific conditions and status of each individual module and/or inverter.

In some examples, the initial value of the maximum temperature setpoint 388 can be set equal to a difference between the maximum allowed temperature 380 and a threshold value. In some examples, the threshold value can be a preconfigured value that can be calculated by the system or can be input by a user. In some examples, a minimum value of the maximum temperature setpoint 388 can be equal to the initial value of the maximum temperature setpoint 388. In some examples, when the generating module temperature 382 reaches the maximum temperature setpoint 388, or is greater than the maximum temperature setpoint 388, the maximum temperature setpoint 388 can be increased.

In some examples, this increase in the maximum temperature setpoint 388 can be proportional to the curtailment factor 394, where the curtailment factor 394 is based in part on a temperature difference 385 between the maximum temperature 390 and the maximum temperature setpoint 388. In some examples, the curtailment factor 394 can be further determined based on the generating module temperature 382 and the maximum temperature 390 of the module and/or inverter. Additionally, when the generating module temperature 382 reaches or exceeds the maximum temperature setpoint 388, the controller 374 can output a power limit 392 that includes a command to limit the power, and in so doing reduce the temperature, of one or more modules and/or inverters. In some examples, the temperatures of modules and/or inverters regulated by the system can increase in temperature in a slow, see-saw-like manner to increase the efficiency of the modules and/or inverters as they heat up. In this manner, the maximum temperature setpoint 388 can be adjusted over time based on temperature data and the curtailment factor 394. In some examples, the maximum temperature setpoint 388 can be decreased when updated when the curtailment factor 394 has a value of zero.

In one or more examples, the system of FIG. 3 can include various interface components. In some examples, the system can include a cloud-hosted platform where users can see the live state of the system and perform supervisory control intervention. In at least one example, the system can have a cloud hosted API to support integrations with other systems.

Any of the features, components, and/or parts, of the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A non-transitory computer-readable medium storing instructions that, when executed by a processor of a computing system, causes the computing system to perform a method for optimizing a solar inverter, the method comprising:
determining a maximum temperature setpoint;
modifying a temperature start point below the maximum temperature setpoint;
adjusting a current temperature of a solar inverter from the temperature start point towards the maximum temperature setpoint by regulating a component temperature of a component of the solar inverter; and
optimizing the current temperature of the solar inverter via making a best choice between power limiting and selective disabling of components within the solar inverter.

2. The non-transitory computer-readable medium of claim 1, wherein the current temperature of the solar inverter is optimized by selectively:
providing a power limit to the solar inverter to maintain the current temperature below the temperature start point; or
selectively disabling one or more of the components to maintain the current temperature below the temperature start point.

3. The non-transitory computer-readable medium of claim 1, wherein:
the code is further executable by the processor of the computing system to calculate a power curtailment for the solar inverter based on the current temperature;
the power limit is provided based on the power curtailment; and
the temperature start point is adjusted to the current temperature of the solar inverter based further on the power curtailment.

4. The non-transitory computer-readable medium of claim 1, wherein:
the maximum temperature setpoint is based on the component of the solar inverter; and
the temperature start point is lower than the maximum temperature setpoint by a threshold value.

5. The non-transitory computer-readable medium of claim 1, wherein the current temperature of the solar inverter is adjustable in a range bounded by the temperature start point and the maximum temperature setpoint.

6. A method for controlling a power inverter, the method comprising:
receiving temperature data from a power inverter module of a power inverter;
determining a power curtailment for the power inverter; and
maintaining the temperature data below a temperature setpoint by selectively:
adjusting a power limit of the power inverter by the power curtailment; or
selectively disabling one or more components of the power inverter.

7. The method of claim 6, further comprising adjusting the temperature setpoint to an adjusted temperature setpoint based on the power curtailment.

8. The method of claim 7, further comprising increasing the temperature setpoint to the adjusted temperature setpoint when the temperature data is greater than the temperature setpoint.

9. The method of claim 8, wherein the temperature setpoint is increased to the adjusted temperature by an amount proportional to the power curtailment.

10. The method of claim 7, further comprising decreasing the temperature setpoint to the adjusted temperature setpoint when the power curtailment is zero.

11. The method of claim 6, wherein the power curtailment is determined based on the temperature data and a maximum allowed temperature of the power inverter module.

12. The method of claim 6, wherein:
an initial value of the temperature setpoint is set equal to a difference between a maximum allowed temperature of the power inverter module and a threshold value; and
a minimum value of the temperature setpoint is equal to the initial value of the temperature setpoint.

13. The method of claim 6, further comprising:
applying a low pass filter to the temperature data to produce filtered temperature data;
wherein the power curtailment is determined based on the filtered temperature data.

14. A system comprising:
an inverter comprising a plurality of power inverter components; and
a controller coupled to the inverter, the inverter configured to:
receive temperature data from the power inverter components;
calculate a calculated power limit for the inverter based on the temperature data;
calculate a power limit lower limit for the inverter based on potential power loss from risk of the power inverter components becoming inoperative; and
adjust a power limit of the inverter to the greater of the calculated power limit or the power limit lower limit.

15. The system of claim 14, wherein the calculated power limit is calculated in a range bounded by a lower limit greater than zero and an upper limit of 100%.

16. The system of claim 14, wherein the calculated power limit is calculated based on:
determining a power curtailment for the inverter, wherein the power curtailment is calculated according to the equation:
$$Power curtailment = \frac{\sum Error loss prediction}{\sum Rated power} ;$$
and
calculating the calculated power limit according to the equation:
$$Power limit = Max ( 0 \% , Min ( 100 \% , 100 \% ⋆ ( max power limit - Power curtailment ) .$$

17. The system of claim 16, further comprising:
calculating a temperature setpoint for the inverter according to the equation:
$$Current temperature setpoint = Previous temperature setpoint + ( \frac{Power Curtailment}{5} ) * Loop Time .$$

18. The system of claim 17, wherein:
the previous temperature setpoint is increased to the current temperature setpoint when the temperature data is greater than the previous temperature setpoint; and
the previous temperature setpoint is decreased to the current temperature setpoint when the power curtailment has a value of zero.

19. The system of claim 14, wherein the power limit lower limit is calculated based on the temperature data, power data received from the power inverter components, and a downtime factor.

20. The system of claim 14, wherein the controller comprises at least one of a proportional controller, an integral controller, a derivative controller, a proportional-integral controller, a proportional-derivative controller, or a proportional-integral-derivative controller.
